(19) United States
(12) Patent Application Publication
(10) Pub. No.: US 2003/0035630 A1
(43) Pub. Date: Feb. 20, 2003

(54) Thermally diffused multi-core waveguide

(76) Inventor: Gerald Meltz, Avon, CT (US)

Correspondence Address: Robert D. Crawford, CiDRA Corporation, 50 Barnes Park North, Wallingford, CT, 06492, US

(21) Appl. No.: 10/098,926

(22) Filed: Mar. 16, 2002

Related U.S. Application Data
(60) Provisional application No. 60/276,454, filed on Mar. 16, 2001.

(51) Int. Cl. G02B 6/26

(52) U.S. Cl. 385/39; 385/129; 385/126

(57) ABSTRACT

A thermally diffused dual-core (TDDC) waveguide is provided that has a pair of spaced cores 12,14 disposed within a cladding 16. The waveguide 10 is formed of a glass material having the appropriate dopants to allow light 15 to propagate in either direction along the cores 12,14. The TDDC waveguide is formed by heating a portion 22 of the dual-core waveguide 10 to symmetrically diffuse the dopants of the cores 12,14 into the cladding 16. Consequently, the optical mode fields of the cores spread beyond the optical mode field of each original core such that the optical field in one core 12 excites the optical field in the adjacent core 14 to optically couple the two cores 12,14. The amount of diffusion of the core into the cladding is dependent on the temperature of the heat and the time the heat is applied to the dual-core waveguide. The cores may be diffused so that the cores overlap to thereby create a unitary core. The TDDC waveguide may be used to provide a coupler or wavelocker device.

### CROSS REFERENCE TO RELATED APPLICATION

This application claims the benefit of U.S. Provisional Application Serial No. 60/276,454, entitled “Thermally Diffused Multi-Core Waveguide”, filed Mar. 16, 2001, which is incorporated herein by reference in its entirety.

### TECHNICAL FIELD

The present invention relates to multi-core optical waveguides, and more particularly to a multi-core optical waveguide, wherein the cores are thermally diffused to provide optical coupling between the cores of the waveguide.

### BACKGROUND ART

Thermal diffusion of the core dopant has been used to modify the mode field diameter of a step-index fiber, as reported by K. Shiraishi et. al. in “Beam Expanding Fiber Using Thermal Diffusion of the Dopant, J. Lightwave Tech., Vol. 6, No. 8, pp. 1151-1161 (August 1990), which is incorporated herein by reference. For example, a fiber encapsulated in a silica tube is placed in a microfurnace and heated to a sufficiently high temperature so that the concentration of a typical lightguide dopant, such as germanium, boron and phosphorous, is changed by diffusing into the cladding. It is known to heat treat at temperatures of 1200-1400°C. for several hours in the furnace to redistribution of germanium in a standard single-mode step-index fiber. The corresponding change in the modal intensity distribution is such that the modal field diameter enlarges without changing the effective value of V, the normalized frequency parameter. An adiabatic up- or down-taper transition from the thermally-expanded section of the fiber to the step-index profile region is achieved by controlling of the axial temperature distribution in the furnace. Other methods of heating the fiber such as a traveling microburner flame or a CO₂ laser are also known to be used to thermally-difflised the dopants.

It has been noted by G. Meltz et. al., “Cross-talk fiber optic temperature sensor”, Applied Optics, Vol. 22, No. 3, pp. 464-477 (February 1983), which is incorporated herein by reference, that thermal diffusion will also modify the cross-talk in dual-core fiber couplers. In a dual-core fiber light in one core couples to the other in a length determined by the spacing of the cores and the index distribution of the cores and cladding. The distance for complete transfer of the light from the input core to the adjacent core and back is referred to as the beat length. Choice of this terminology is appropriate because cross-talk can be regarded as interference between the two lowest- order modes in a dual-core fiber, namely the symmetric and anti-symmetric super-modes.

Further, it is known that an evanescent coupler made by fusing a short length of elliptical core D-shaped fiber could be tuned by heating the fused section of the fiber.

### SUMMARY OF THE INVENTION

An object of the present invention is to provide a thermally-diffused dual core waveguide for coupling light propagating through a first core into the second core.

In accordance with an embodiment of the present invention, an optical waveguide comprises at least a first core and a second core disposed within a cladding. The first and second cores includes a dopant, wherein the dopants of a portion of the first and second core are thermally-diffused into the cladding to permit light that propagates in the first core to optically couple to the second core.

In accordance with another embodiment of the present invention, an optical wavelocker comprises an optical waveguide that includes at least a first core and a second core disposed within a cladding. The first and second cores includes a dopant, wherein the dopants of a portion of the first and second core are thermally-diffused into the cladding to permit light that propagates in the first core to optically couple to the second core. At least one photodetector generates at least one electrical signal, which is representative of the light exiting the at least one of the first core and the second core.

In accordance with another embodiment of the present invention, a method for forming a thermally-diffused dual core waveguide providing a waveguide having at least a first core and a second core disposed within a cladding. The first and second cores include a dopant. A portion of the waveguide is heated for a predetermined time and temperature to thermally-diffuse the dopants of a portion of the first and second core into the cladding to permit light that propagates in the first core to optically couple to the second core.

In accordance with another embodiment of the present invention, an optical sensor comprises an optical waveguide that includes at least a first core and a second core disposed within a cladding. The first and second cores have a dopant, wherein the dopants of a portion of the first and second core are thermally-difflised into the cladding to permit light that propagates in the first core to optically couple to the second core. At least one photodetector generates at least one electrical signal representative of the light exiting the first core and the light exiting the second core, wherein the intensity of light coupling from the first core to the second core is dependent on at least one of the temperature and pressure applied to the optical waveguide.

The foregoing and other objects, features and advantages of the present invention will become more apparent in light of the following detailed description of exemplary embodiments thereof.

### BRIEF DESCRIPTION OF THE DRAWINGS

FIG. 1 is a dual core optical waveguide prior to thermal-diffusion of a portion of the waveguide in accordance with the present invention;

FIG. 2 is a thermally diffused dual core (TDDC) optical waveguide in accordance with the present invention;

FIG. 3 is graphical representation of cross sectional view of the waveguide of FIG. 1;

FIGS. 4 and 5 are plots of the refractive index profile of respective TDDC waveguides having different core spacings, in accordance with the present invention;

FIG. 6 is a plot of the beat length of a TDDC waveguide of the present invention as a function of the normalized diffusivity for two values of the normalized core separation;

FIGS. 7-10 is a pictorial view of the mode fields of different TDDC waveguides, in accordance with another embodiment of the present invention;

FIG. 11 is a block diagram of an optical wavelocker having a TDDC waveguide, in accordance with another embodiment of the present invention;

FIG. 12 is a plot of the beat length of a TDDC waveguide of the present invention as a function of the normalized diffusivity for two values of the normalized core spacing;

FIG. 13 is a plot of the beat length of a TDDC waveguide of the present invention as a function of the normalized diffusivity for several values of core diameter;

FIG. 14 is a block diagram of another embodiment of an optical wavelocker having a TDDC waveguide, in accordance with another embodiment of the present invention;

FIG. 15 is a block diagram of an optical sensor having a TDDC waveguide, in accordance with another embodiment of the present invention;

FIG. 16 is a plot of the beat temperature of a step-index dual core fiber as a function of core size for a step-index dual core waveguide;

FIG. 17 is a plot of the beat strain of a step-index fiber as a function of the core spacing; and

FIG. 18 is a plot of the beat strain of a step-index fiber as a function of V.

### BEST MODE FOR CARRYING OUT THE INVENTION

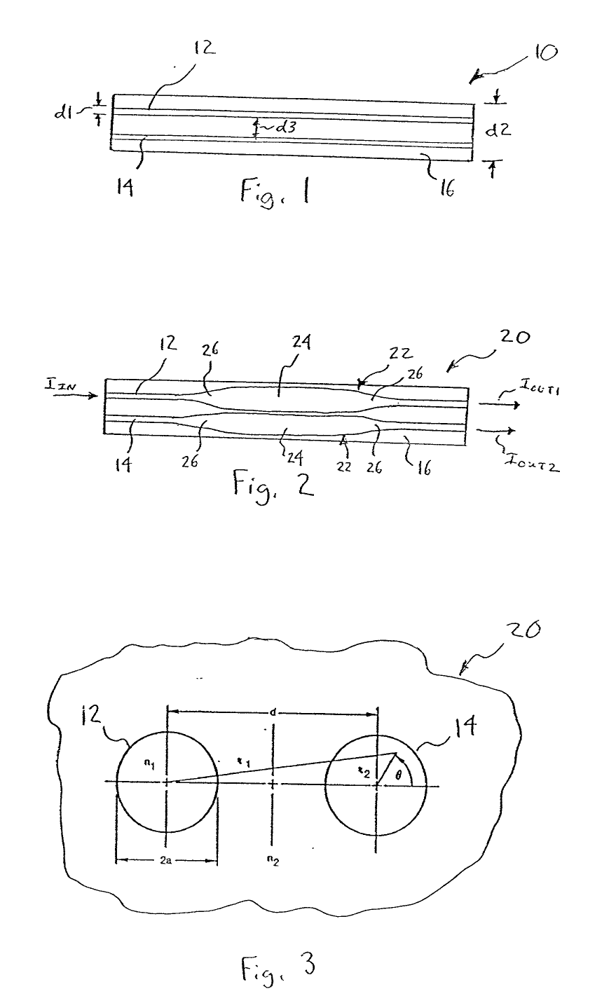

Referring to FIG. 1, a dual-core waveguide, generally shown as 10, comprises a pair of spaced cores 12,14 disposed within a cladding 16. The waveguide 10 comprises a glass material (e.g., silica glass (SiO₂), phosphate glass and other glass material) having the appropriate dopants, as is known, to allow light 15 to propagate in either direction along the cores 12,14.

The dual core waveguide 10 may be an optical fiber, wherein the cladding 16 has an outer dimension d2 of approximately 125 microns (μm). In one embodiment, as shown in FIG. 1, the cores may be substantially the same, wherein the composition, geometry and/or diameter are the same. Each core 12,14 may have an initial outer dimension d1 such that each core propagates only a few spatial modes (e.g., less than about 6 spatial modes). For example for single spatial mode propagation, each core 12,14 has a substantially circular transverse cross-sectional shape with a diameter d1 less than about 12.5 microns, depending on the wavelength of light propagating through the core. The invention will also work with larger or non-circular cores (e.g., elliptical shape) that propagate a few spatial modes (less than about 6 spatial modes), in one or more transverse directions. Alternatively, the cores may be different, wherein the composition, geometry and/or diameters are different.

The cores may be spaced to form an optical coupler, such that light propagating through one core 12 transfers completely to the second core 14 over one half of the beat length L_{b}. The beat length is dependent on the spacing between the cores, composition of the core and shape of the core. Alternatively, the cores 12, 14 may be spaced apart a predetermined distance d3 to prevent optical coupling therebetween.

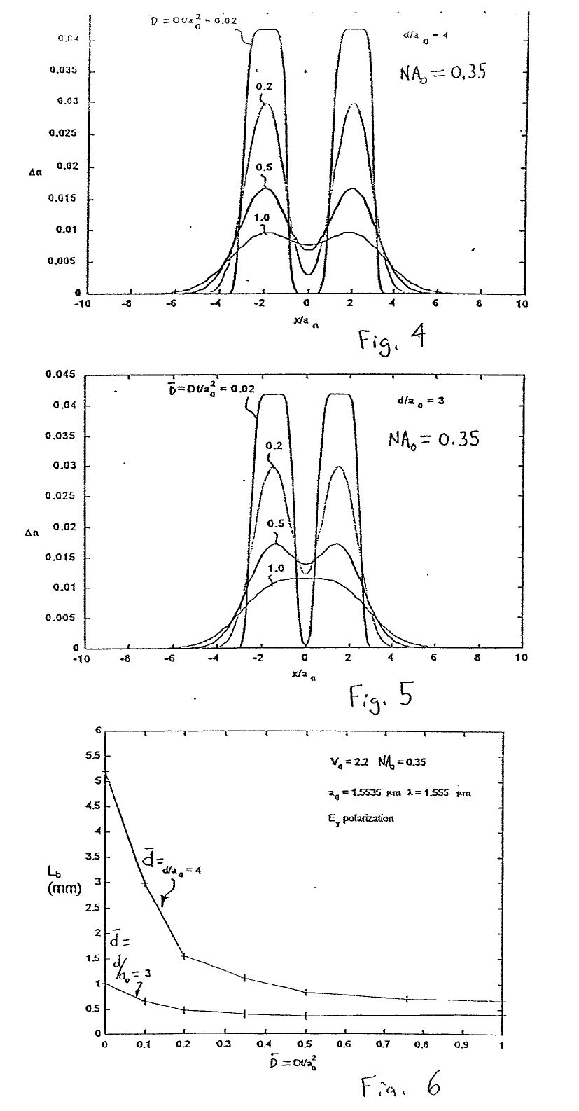

Referring to FIG. 2, a portion 22 of the dual-core waveguide 10 may be heated to symmetrically diffuse the dopants (e.g., Germanium and Boron) of the cores 12,14 into the cladding 16 to form a thermally diffused dual core (TDDC) fiber 20. Consequently, the optical mode fields of the cores spread beyond the optical mode field of each original core such that the optical field in one core 12 excites the optical field in the adjacent core 14 to optically couple the two cores 12,14. The amount of diffusion of the core into the cladding is dependent on the temperature of the heat and the time the heat is applied to the dual-core waveguide, as will be described in greater detail hereinafter. The dual core waveguide 10 is heated to provide an intermediate region 24 of the thermally-diffused portion 22 of each core of the TDDC fiber 20 that have a substantially uniform cross-section over its length, while the transition regions 26 disposed at the ends of the thermally-diffused portions 22 taper to smoothly join adiabatically the mode fields of the intermediate portions 24 to the more widely separated the step-index regions 28 of the TDDC fiber 20. The length of the intermediate regions 24 of the thermally-diffused portions 22 may be any desired length, but is typically made as short as possible to reduce temperature dependent changes in coupling and to make the TDDC fiber 20 as compact as possible.

Alternatively, the cores 12,14 may be diffused such that the dopants of the cores overlap to produce a unitary core, which will be described in greater detail hereinafter. The diffusion initially produces an elliptical core, but eventually the unitary core becomes circular. Both circular and elliptical geometries are useful in the present invention.

As suggested hereinbefore, the thermally diffused dual core fiber 20 of FIG. 2 may function as an optical coupler, referred to as a “TDDC coupler”. TDDC couplers can be used to split an optical input signal into two outputs having given ratios of intensities, combine two wavelengths into a common fiber and provide 2×2 directional coupling. For example, a percentage of an input light (I_{IN}) incident to an input end of core 12 of the TDDC fiber 20 is optically transferred to the output end of the second core 14. In other words, the input light I_{IN} is split between the output ends of cores 12,14 to provide respective output light I_{OUT1}, I_{OUT2}. The percentage of light I_{OUT2} transferred to the second core 14 is dependent on the overall length and properties of the thermally-diffused regions, as will described in greater detail hereinafter. In one instance, all the incident light (I_{IN}) completely transfers to the other core 12 when the length of the thermally diffused portion 22 is substantially equal to one half of the beat length L_{b}.

Advantageously, the present invention permits a TDDC coupler 20 to have a very short beat length L_{b} without using very closely-spaced cores, which results in low insertion loss and high visibility. Further, the present invention permits the TDDC coupler to have a comparatively short beat length and thick cladding, which allows the TDDC coupler to be tuned with a compressive stress without buckling.

The TDDC fiber 20 may be thermally-diffused using known methods, similar to those described hereinbefore, such as by heating the dual-core waveguide 10 with a CO₂ laser or other heat sources. The temperature and heating time to form/manufacture a TDDC fiber 20, having a predetermined, two-dimensional index distribution, may be determined using a Green's function approach, to solve the diffusion equation (Eqn. (1)) and determine an expression for the profile of the index of refraction.

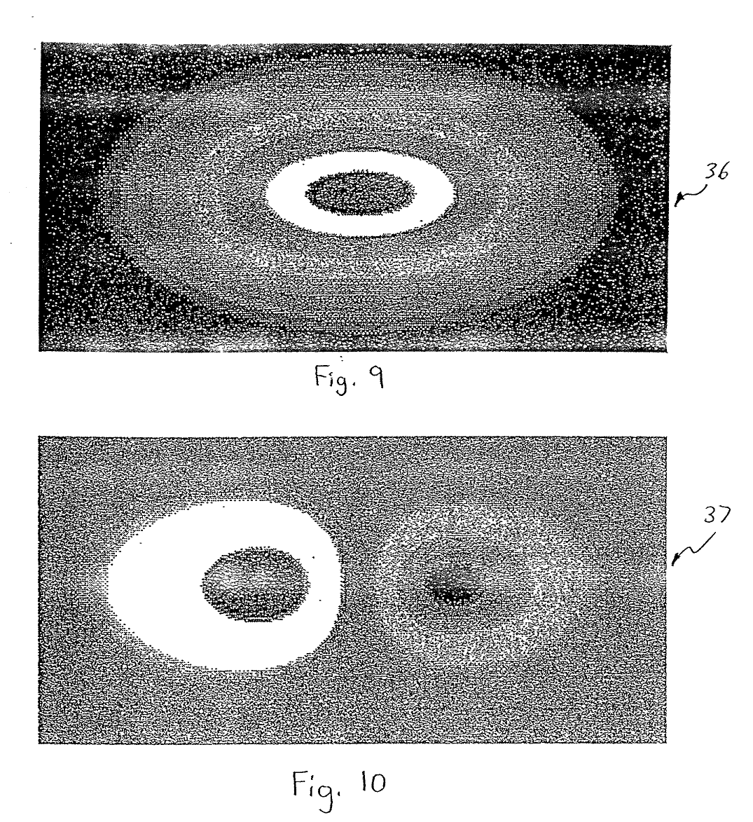

Using the well-known solutions for diffusion of a uniform cylindrical concentration of dopant, one can show that the core dopant concentration C(x,y,t) at a location (x,y) after a heating time t is defined by the following diffusion equation:

$$C ( x , y ; t ) = ( {C}_{0} / 2 Dt ) [ {ⅇ}^{- {r}_{1}^{2} / 4 Dt} {\int }_{0}^{{a}_{0}} {ⅇ}^{- {r}^{′2} / 4 Dt} \cdot {I}_{0} ( \frac{{r}_{1} {r}^{′}}{2 Dt} ) {r}^{′} ⅆ {r}^{′} + {ⅇ}^{- {r}_{2}^{2} / 4 Dt} {\int }_{0}^{{a}_{0}} {ⅇ}^{- {r}^{′2} / 4 Dt} \cdot {I}_{0} ( \frac{{r}_{2} {r}^{′}}{2 Dt} ) {r}^{′} ⅆ {r}^{′} ] \qquad ( 1 )$$

where r₁=r₂=[y²+(d/2±x)²]^{½}; r₁ is the distance from the axis of core 12 to the position x,y; r₂ is the distance from the axis of core 14 to the position x,y; d is the distance between the axes of the cores as shown in FIG.4; D is the dopant diffusion coefficient; a₀ is the initial core radius; I₀ is the modified Bessel function of the first kind of order zero; and C₀ is the initial core dopant concentration. Generally, D obeys an Arrhenius law defined by the following equation:

D=D₀ exp(−Q/(8.31 T) (2)

where D₀ is the initial diffusion coefficient; Q is the activation energy in joules/mole; and T is the absolute temperature in °K. The value of D depends not only on the core dopant but also on the fiber fabrication method. For instance, typical values for Germanium in a fiber made by a standard modified chemical vapor deposition (MCVD) process are Q=1.5×10⁵ J/mole and D₀=5.7×10⁻¹¹ m²/sec.

It is useful to introduce a normalized diffusion coefficient \overline{D}≡Dt/a₀² and normalized coordinates

$$\overline{x} ≡ x / {a}_{0} and \overline{y} ≡ y / {a}_{0} .$$

At a temperature of 1300° C.,

$$\overline{D} = 1.3422 \cdot ( t / 1 hr ) \cdot {( {a}_{0} / 1.26 μ m )}^{- 2} \qquad ( 3 )$$

Using these variables, an index of refraction profile may be determined for the TTDC fiber 20, which is defined by the following equation:

n(x,y)=[NA₀²C(x,y)/C₀+n₂²]^{½} (4)

where NA₀ is the numerical aperture of the individual step-index cores and n₂ is the refractive index of the cladding.

FIG. 4 illustrates a family of the refractive index profiles along the line-of-centers (x-axis) in a TDDC fiber 20 having a normalized spacing of d/a₀=4. Each refractive index profile represents a TDDC fiber 20 having a different normalized diffusion coefficient \overline{D}≡Dt/a₀² having values 0.02, 0.2, 0.5, and 1.0. For small values of \overline{D} when the TDDC fiber 20 is heated for a relatively short period of time, the cores 12,14 remain separated and approximately circular. For larger values of \overline{D} when the TDDC fiber 20 is heated for a longer period of time (about an hour), the separation between the cores 12,14 become closer, eventually, diffusing into one another resulting in the cores merging and becoming quasi-elliptical in shape.

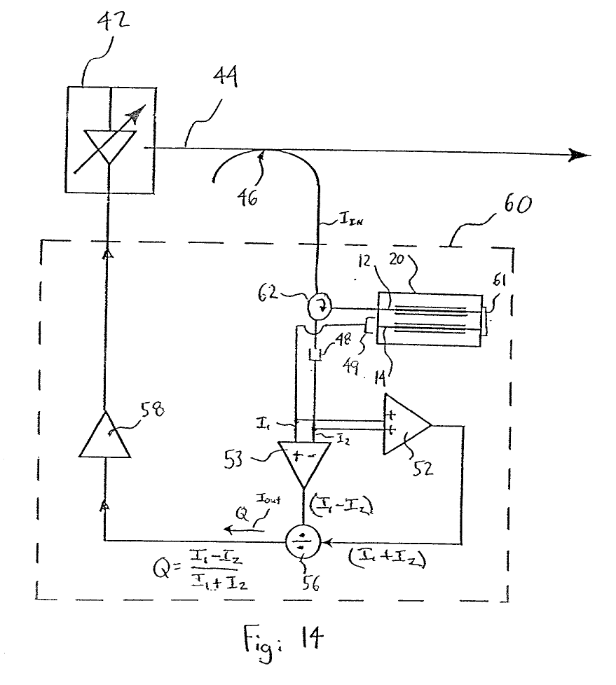

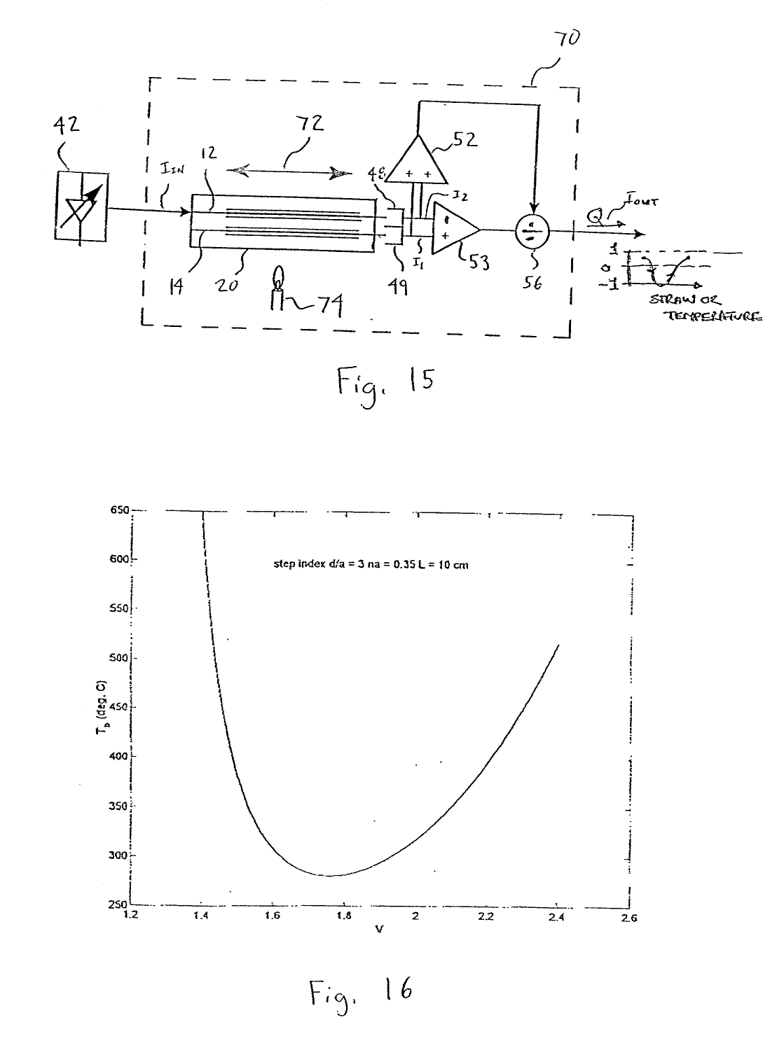

Contour diagrams of the E_{y} electric field amplitudes in the symmetric mode and asymmetric mode are shown in FIGS. 7 and 8, respectively, for the lowest order modes in a TDDC fiber 20, which has been heated at 1300° C. for 1 hour (e.g., high value of \overline{D}), wherein the cores 12,14 have partially fused together. The TDDC fiber 20 is defined by the following parameters: a₀=1.5535 μm; d=4, \overline{D}=0.94, NA₀=0.35, V₀=2.2, and λ=1555 nm. The resulting beat length L_{b} is approximately 0.679 mm. The beat length is only weakly dependent on the polarization of the light source or input signal.

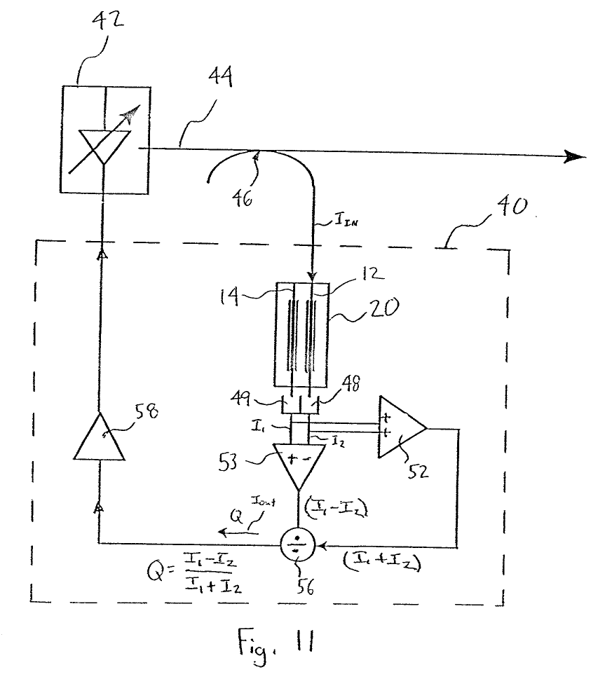

FIG. 5 illustrates a family of the refractive index profiles along the line-of-centers (x-axis) in a TDDC fiber 20 similar to that shown in FIG. 4 except the cores 12,14 are more closely separated, wherein the normalized spacing of the cores is d/a₀=3. Each refractive index profiles represent a TDDC fiber having a different normalized diffusion coefficient \overline{D}≡Dt/a₀² having values 0.02, 0.2, 0.5, and 1.0. For small values of \overline{D} when the TDDC fiber 20 is heated for a relatively short period of time, the cores 12,14 remain separated and approximately circular. For larger values of \overline{D} when the TDDC fiber is heated for a longer period of time (about an hour) then separation between the cores 12,14 become closer, eventually, diffusing into one another resulting in the cores merging and becoming quasi-elliptical in shape.

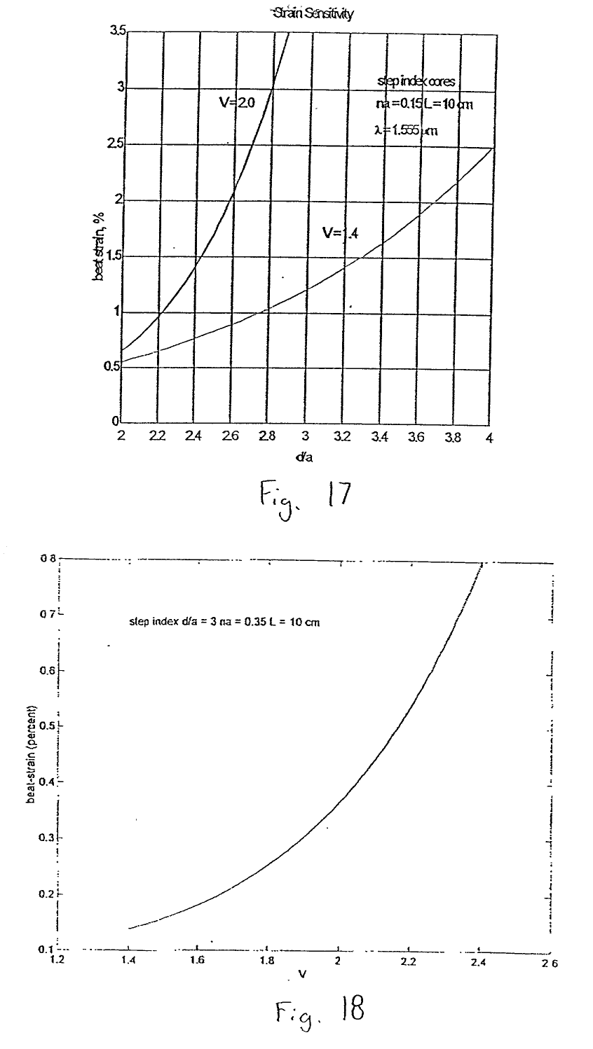

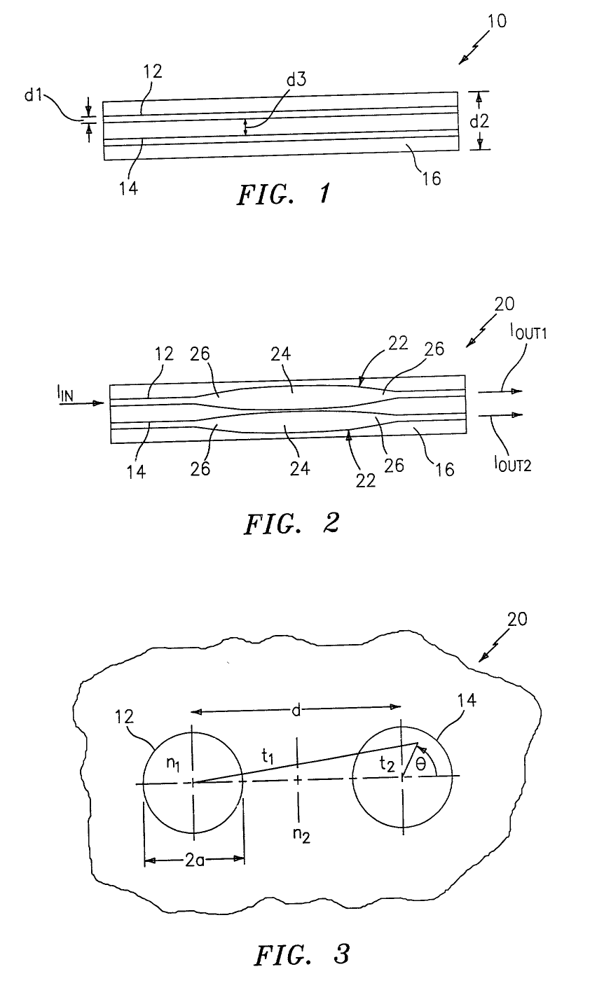

Contour diagrams of the E_{y} electric field amplitudes in the symmetric mode and asymmetric mode are shown in FIGS. 9 and 10, respectively, for the lowest order modes in a TDDC fiber, which has been heated at 1300° C. for 1 hour (e.g., high value of \overline{D}), wherein the cores have partially fused together. The TDDC fiber is defined by the following parameters: a₀=1.5535 μm; d=3, \overline{D}=0.94, NA₀=0.35, V₀=2.2, and λ=1555 nm. The resulting beat length L_{b} is approximately 0.4016 mm. The beat length is only weakly dependent on the polarization of the light source or input fiber.

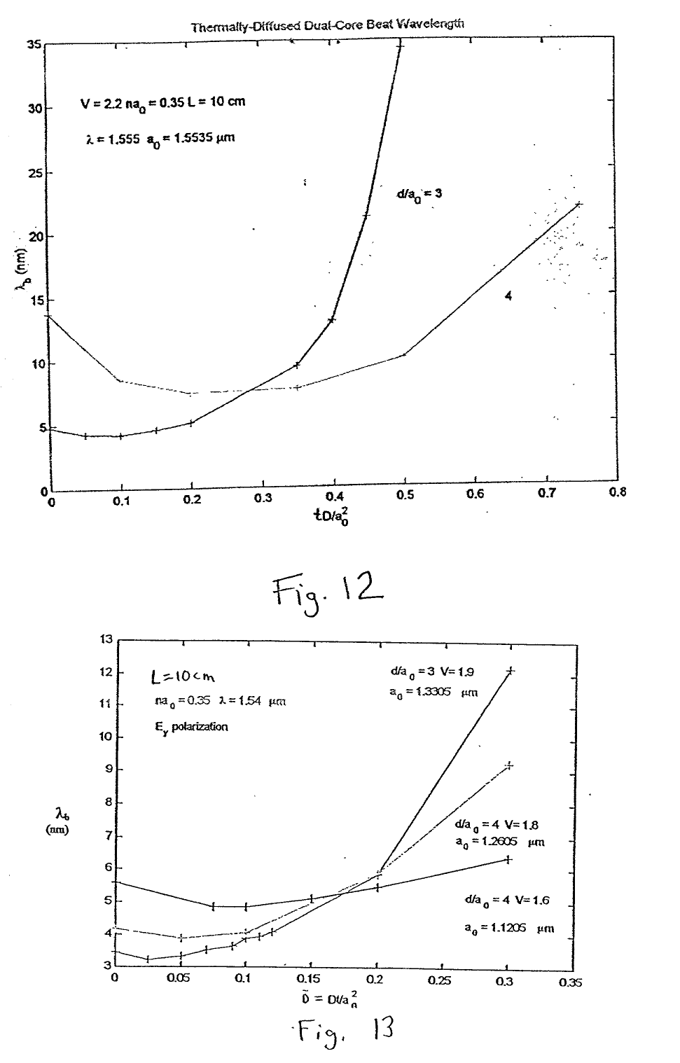

FIG. 6 is a graphical representation of the beat length of the TDDC fibers 20 described hereinbefore in FIGS. 7-10 as a function of the normalized diffusivity \overline{D} having normalized core separation d/a₀ values of 3 and 4, respectively. In other words, the graphical representation of FIG. 6 shows finite difference calculations of L_{b} as a function of the heating time for a particular value of a₀. As shown, a dual core fiber 10 having the cores spaced a diameter apart (d/a₀=4) and heating of the center section at 1300° C. for approximately one hour will shorten the beat length L_{b} from about 5 mm to 0.68 mm. These results can be scaled to other values of the numerical aperture by noting that L_{b} is approximately proportional to NA₀².

Referring to FIG. 1, a wavelocker device 40 is shown comprising a TDDC fiber 20, which provides a feedback signal indicative of the output wavelength of a tunable laser 42. The feedback is provided back to the laser to lock the laser's output to a predetermined wavelength. The tunable laser 42 provides a light source that propagates through an optical fiber 44. A directional coupler 46 taps a small amount of the laser light and provides the light to the TDDC fiber 20 of the wavelocker device 40. The tapped light is coupled to the input of core 12 of the TDDC fiber 20, which transfers a percentage of the input light to core 14, while propagating the remaining light from the output of core 12. The TDDC fiber 20 is designed to provide an equal intensity of light I₁,I₂ from the output of each core 12,14 for a predetermined wavelength of light input I₀ into core 12. The output of each core 12,14 is detected by a respective photodetector 48,49. The output signal I₁,I₂ of each photodetector is provided to a pair of amplifiers 52,53. The amplifiers combine and normalize the output signals of the photodetectors 48,49 to provide an error signal Iₒᵤₜ proportional to the core visibility function Q. Specifically, amplifier 52 sums the output signals I₁,I₂, while amplifier 53 provides the difference between the output signals. A divider 56 divides the output signal of amplifier 53 by the output signal of amplifier 52 to provide the error signal Iₒᵤₜ. The error signal may be amplified by amplifier 58 before being provided to the controller of thermal or current tuning laser 42 to adjust and lock the wavelength to the desire value.

The TTDC fiber 20 may be tuned by straining the fiber to set the nulls in Q to the desired wavelength(s) (i.e., the laser output wavelength) by using a wavemeter to calibrate the adjustment. One will appreciate that other methods of tuning the TDDC fiber 20 may be used, such as thermal tuning and other methods, as described in U.S. Pat. No. 5,007,705, which is incorporated herein by reference in its entirety.

The TDDC fiber 20 can be designed from the following model. Complete energy exchange from the illuminated to the unilluminated core and back takes place in one half of the beat length L_{b}. The variation in intensity in each core at the end of the effective length L of the TDDC fiber 20 is a simple periodic function of the beat phase φ=πL/L_{b}. The relative intensity Q at the output of the wavelocker device 40 is given by the equation:

$$Q = \frac{{I}_{1} - {I}_{2}}{{I}_{1} + {I}_{2}} = {cos}^{2} φ - {sin}^{2} φ = cos 2 φ \qquad ( 5 )$$

where I₁ and I₂ refer to the intensities in each core. A phase shift of π radians cycles the core contrast or visibility function Q through a complete period.

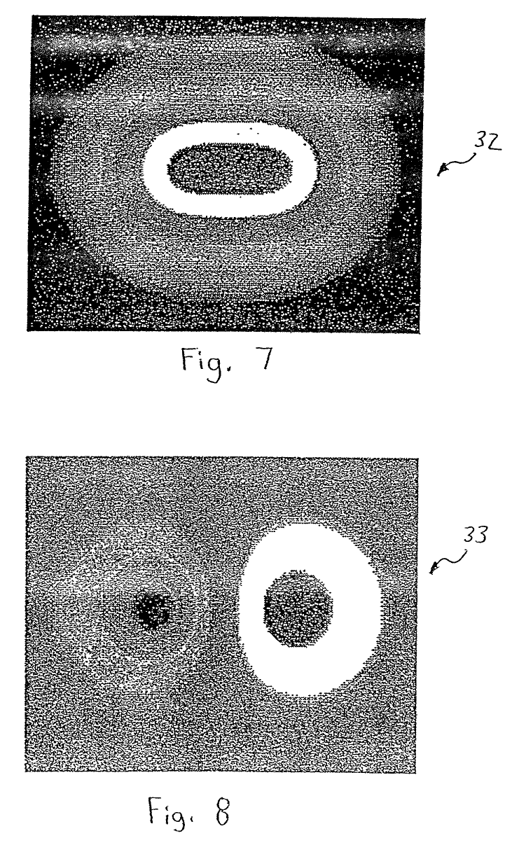

Application of coupled-mode theory leads to an expression for the beat length in terms of a field overlap integral, which is a measure of the interaction between the individual single-core modes (see FIG. 3):

$$π / {L}_{b} = ( {NA}^{2} / λ {n}_{1} ) ( 1 / {a}^{2} ) {\int }_{{A}_{2}} s ( {r}_{2}^{2} / {a}^{2} ) {ψ}_{1} ( {r}_{1} ) {ψ}_{2} ( {r}_{2} ) {r}_{2} ⅆ {r}_{2} ⅆ θ \qquad ( 6 )$$

(6)

where λ is the wavelength; n₁ is the index of refraction of the core; r₁ is the distance from the axis of core 12 to the position x,y; r₂ is the distance from the axis of core 14 to the position x,y; a is the radius of the core; dθ is adzimuthal angle of r₂ and where the radial variation of the refractive index is described by the profile function

s(r₂²/α²)=[n²(π₂²/α²)−n₂²]/NA² (7)

with NA²=n(0)²−n₂², where n(0) is index of refraction of the core and n₂ is index of refraction of the cladding. The functions ψ₁ and ψ₂ are proportional to the principal components of the transverse electric field of a single-core mode centered on core 1 or core 2, respectively. It is convenient to introduce a coupling factor F(V;d/a) defined by

$$F ( V ; d / a ) = V / 2 π {\int }_{{A}_{2}} s {ψ}_{1} {ψ}_{2} ( {r}_{2} / a ) ⅆ ( {r}_{2} / a ) ⅆ θ \qquad ( 8 )$$

Equation (8) can be evaluated in closed form for both step-index and Gaussian profile cores [ref. 2]. The coupling factor for these two cores is given in Table 1.

TABLE I
Coupling Factor

| | | |
|---|---|---|
| Core Profile | s(r²/a²) | F(V,d/a), where V = 2 π/λ · a · NA |
| Step | 1 for na ≧ 1 | (U²/V³)K₀(Wd/a)/Kₗ²(W) |
| | 0 for r/a > 1 | W = (V² − U²)^{1/2} |
| | | U = (1 + √2)V/[1 + (4 + V⁴)^{1/4} |
| Gaussian | exp(−r²/a²) | (V − 1)V^{3/(V + 1)}²exp[(V − 1)²/(V + 1)] · K₀[(V − 1)d/a] |

The exchange of energy between cores can be analyzed in terms of modal interference. To a very good approximation, the twin-core normal modes are linear combinations of the lowest-order HE₁₁ (which is the single core guided mode) single-core excitations. There are two orthogonally polarized, symmetric and asymmetric pairs of HE₁₁ modes. Illumination of a single core is equivalent to the excitation of a pair of normal modes, namely, a symmetric and asymmetric combination with the same polarization.

Equations (6) and (8) can be combined to give the useful design equation

L_{b}/λ=½·n₁/NA²·V/F (9)

Note that the beat length scales inversely as NA².

For the same numerical aperture and relative normalized core spacing d/a₀, a Gaussian profile fiber core will have a significantly shorter beat length. The beat length can be reduced to a fraction of a millimeter by an appropriate selection of glasses, core size, and spacing.

As is known, the coupled-mode (C-M) model is adequate for estimating the beat length of a dual-core fiber and for determining the wavelength dependence of cross-talk and the temperature and strain sensitivity. However, if the cores are very closely spaced or overlapping, then C-M model is less accurate and it is necessary to use an exact numerical solution of the wave equation to compute the beat length and its variation with wavelength.

The wavelength dependence of the beat phase can be derived from an exact finite difference calculation or approximately from Eqs. (8) and (9):

dφ/dλ=−(πL/L_{b}²)∂L_{b} /∂λ=−(2 πL/λ²)(NA²/n₁)dF/dV (10)

where L is the length of the coupling region (i.e., waveguide length).

To first order, the change in wavelength required to for a complete cross-talk cycle or the beat wavelength λ_{b} is given by equation:

λ_{b}=−(L_{b}/L)/∂(1nL_{b})/∂λ (11)

or when coupled mode analysis is valid, by equation:

$${λ}_{b} = - \frac{{λ}^{2} {n}_{1}}{2 {LNA}^{2} dF / dV}$$

Note that beat wavelength λ_{b} scales inversely with length L and numerical aperture NA squared of the TDDC fiber 20. It also depends on dF/dV and not F; thus the most sensitive design will not be the one, which has the shortest beat length. Since V is the normalized optical frequency, the same expression can also be used to determine the beat frequency f_{b}, by just evaluating it as a function of frequency after making the substitution f_{b}=c/λ_{b}, where c is the speed of light.

Consider a specific design objective of providing an embodiment that will lock the frequency of a semi-conductor laser to a desired channel in the 100 GHz spaced ITU grid. The analysis shows that it is possible to design a TDDC fiber design can be used for multichannel operation over the Erbium-doped fiber amplifier (EDFA) C-band with a frequency spacing of 200 GHz (about a wavelength interval of 1.6 nm) with tradeoffs can made between the fiber length, core separation, index profile and the numerical aperture. The wavelocker may operate as a linear discriminator that is tuned to provide feedback representative of the null in the visibility between the output light I₁, I₂ of the cores 12,14 of the TDDC fiber 20. Alternatively, the wavelocker may operate as a quadratic discriminator that is tuned to provide feedback representative of the maximum contrast (Q) between the light of output light I₁, I₂ of the cores of the TDDC fiber 20. In either mode, there are two operating points for each wavelength interval λ_{b}.

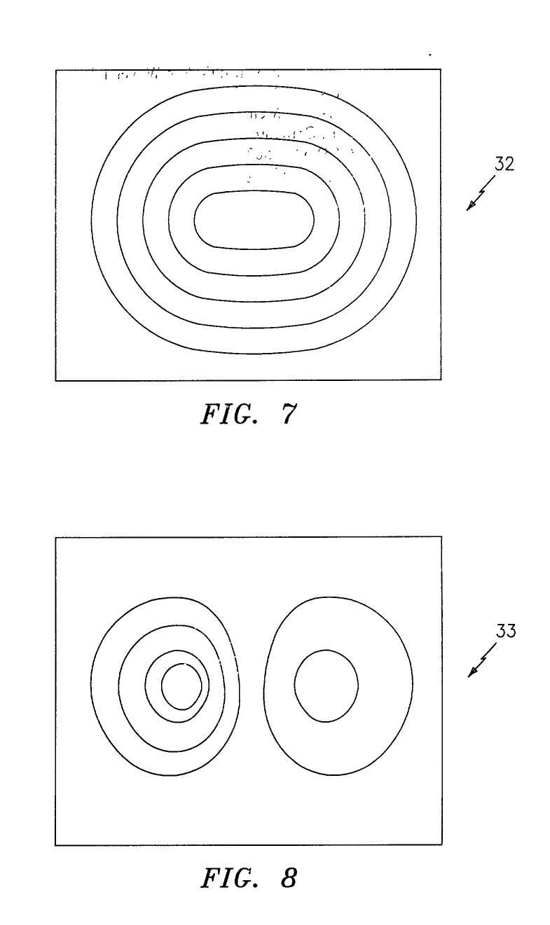

FIG. 12 shows a pair of plots representative of the beat wavelength λ_{b} of a TDDC fiber 20 as a function of its normalized diffusivity \overline{D}, where the V=2.2, NA₀=0.35, L=10 cm. a₀=1.5535 μm, and the wavelength of the input signal is 1.555 μm. The plots represent a TDDC fiber 20 having a core spacing (d/a₀) of 3 and 4, respectively. For a TDDC fiber having cores 12,14 spaced by a core diameter (d/a₀) equal to 4, \overline{D}=0.2, and an effective TDDC length L of 10 cm, the operating points at λ_{b}/2 are spaced by 3.7 nm. The desired spacing of 1.6 nm or 200 GHz can be obtained by increasing the length L of the TDDC fiber to 23.13 cm. Alternatively, the core diameter may be reduced with less diffusion of the core dopant to achieve the desired spacing of 1.6 nm.

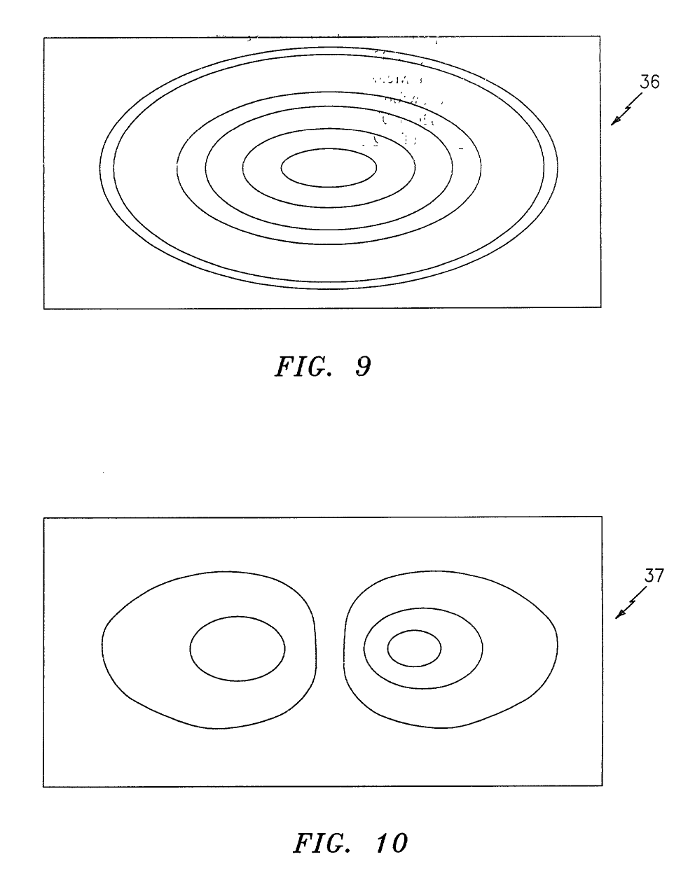

FIG. 13 shows three plots representative of the beat wavelength λ_{b} of a TDDC fiber 20 as a function of its normalized diffusivity \overline{D}, where the NA₀=0.35, L=10 cm, and the wavelength of the input signal is 1.54 μm. One plot represents a TDDC fiber 20 having a core spacing (d/a₀) of 3, V=1.9 and core spacing of 1.3305 μm. A second plot represents a TDDC fiber 20 having a core spacing (d/a₀) of 4, V=1.8 and core spacing of 1.2605 μm. A third plot represents a TDDC fiber 20 having a core spacing (d/a₀) of 4, V=1.6 and core spacing of 1.1205 μm.

For a TDDC fiber 20 having cores 12,14 spaced by a core diameter (d/a₀) equal to 4 and a V value of 1.8, the beat wavelength λ_{b} equals 3.9 nm. One will appreciate that the length L and numerical aperature NA of the TDDC fiber 20 may also be varied to achieve a desired beat wavelength.

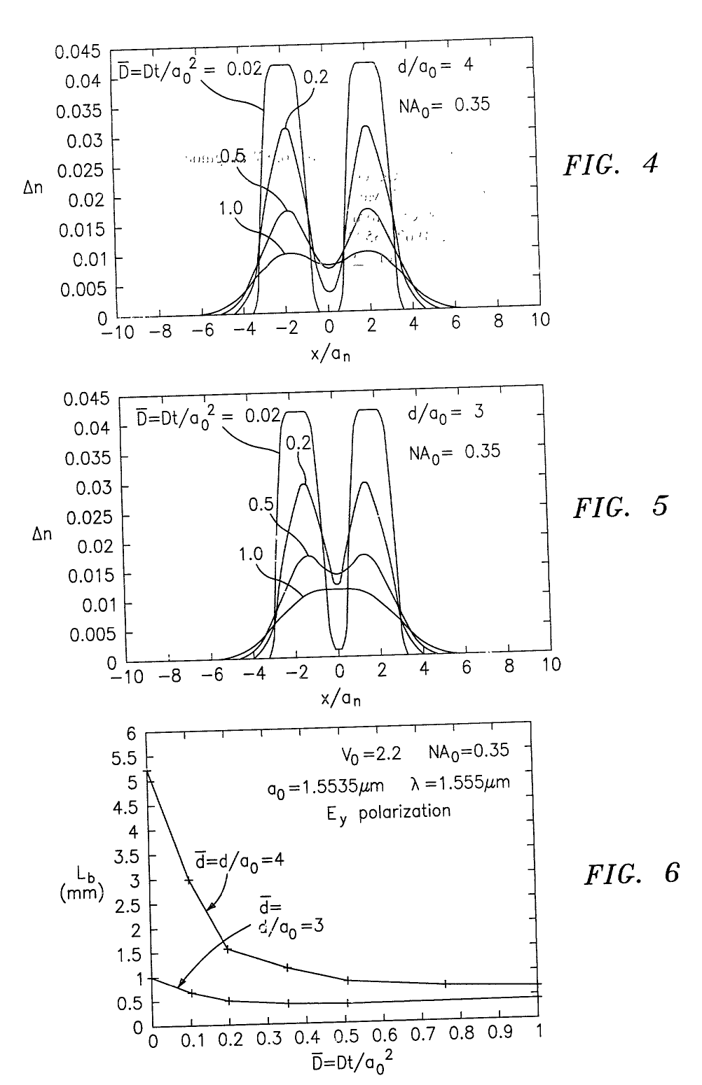

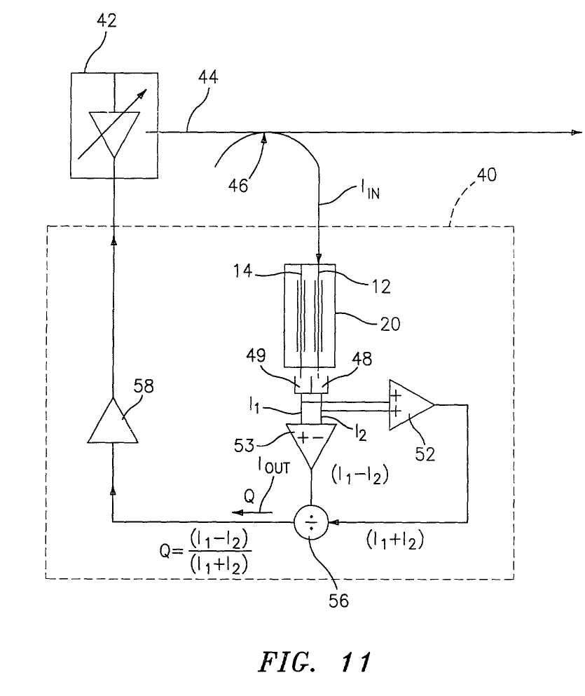

FIG. 14 shows another wavelocker 60 that is similar to the wavelocker 40 of FIG. 11 and therefore, similar components having the same function have the same reference numeral. The wavelocker 60 decreases the operating points to a spacing of 100 GHz or less by reflecting the light at the end of the TDDC fiber 20 off a reflective surface 61 to thereby effectively double the length of the TDDC fiber. A circulator 62 directs the input light I_{IN} to the first core 12 and directs the light reflected back from the mirror to the photodetector 48. Alternatively the circulator 62 may be substituted with a coupler and isolator (not shown). The other photodetector 49 is disposed to sense the output light reflected back through the second core 14. As described hereinbefore, the photodetectors 48, 49 generate electrical signals I₁, I₂ representative of the intensity of the output light of the TDDC fiber. If the feedback control uses the quadratic discriminator point then a high-performance isolator 62 is not as critical since nearly all the reflected light will appear in core 14 adjacent to the input core 12.

The form factor of the device can be reduced by winding the TDDC onto a coil. However, care must be taken that the line joining the core centers remains in the plane of the bend.

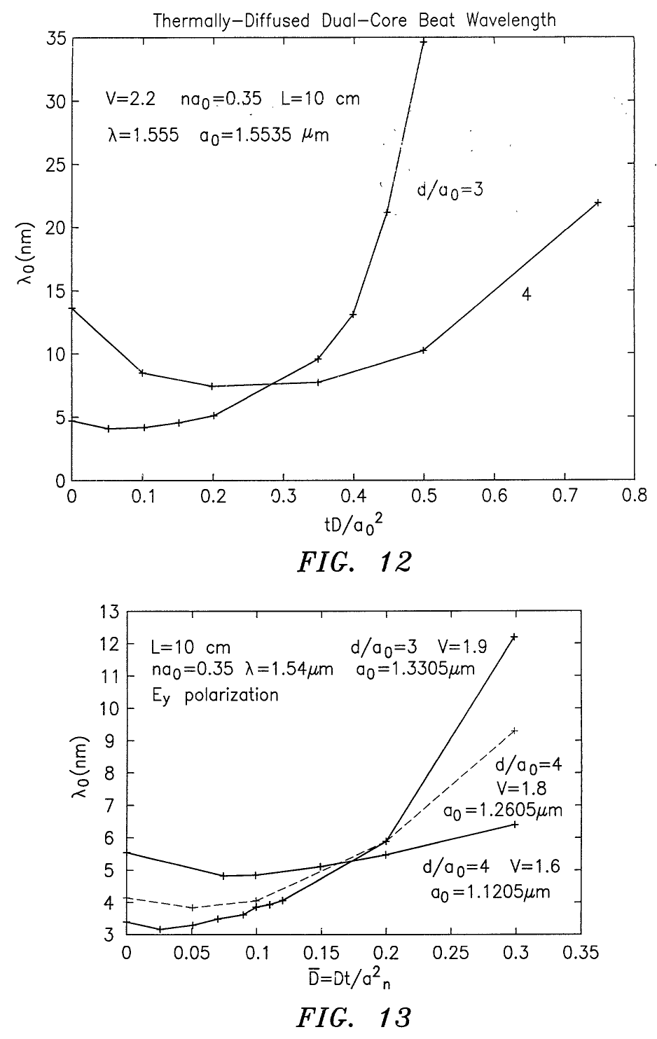

As shown in FIG. 15, another embodiment of the present invention is a dual-core sensor 70. A measurerand, such as an applied strain 70 or temperature change 74, causes a change in the beat length L_{b} and an expansion or contraction of the TDDC fiber 20; the net effect is a change in the beat phase φ and the visibility Q. A tunable laser 42 provides an optical signal, which is used to launch light I_{IN} into one of the cores 12,14. Light is collected from the output ends of the cores, 12,14 respectively, of the TDDC fiber 20 and converted into electrical signals I₁, I₂ by the photodetectors 49,48 respectively. These electrical signals I₁, I₂ are processed, as describe hereinbefore to form a visibility function Q=(I₁−I₂)/(I₁+I₂) which is independent of the laser intensity. The measurerand is determined by extracting the change in the beat phase from the visibility Q and comparing it with a look-up calibration table. The wavelocker 70 is similar to the wavelocker 40 of FIG. 11 and therefore, similar components having the same function have the same reference numeral.

The sensitivity of the TDDC fiber 20 to a perturbation ξ is determined by the equation:

$$\frac{ⅆ φ}{ⅆ ξ} = π L / {L}_{b} ( \frac{1}{L} \frac{ⅆ L}{ⅆ ξ} - 1 / {L}_{b} \frac{ⅆ {L}_{b}}{ⅆ ξ} ) \qquad ( 12 )$$

A change in temperature will cause a change in the dimensions of the TDDC fiber 20 and in the refractive indices of the cladding and cores. In general, both the thermal coefficient of linear expansion α and the thermal coefficient of the refractive-index variation ζ will be different in the core and cladding; however to simplify the discussion assume that the expansions coefficients are equal.

If the TDDC fiber 20 is free to expand, the fractional change in the beat phase Δφ/φ due to a temperature change ΔT is given by the equation:

$$Δ φ / φ = \{ \frac{n \frac{2}{2}}{n \frac{2}{1} - {n}_{2}^{2}} ( {ζ}_{1} - {ζ}_{2} ) + ( V / F ) dF / dV [ α + {ζ}_{1} + \frac{{n}_{2}^{2}}{{n}_{2}^{1} - {n}_{2}^{2}} ( {ζ}_{1} - {ζ}_{2} ) ] \} Δ T$$

where the subscript refers to the quantity in the cores “1” or in the cladding “2”.

If ζ₁ equals ζ₂, the sensitivity to temperature variations simplifies to

$$\frac{ⅆ φ}{ⅆ T} = ( 2 π L / λ ) ( {NA}^{2} / {n}_{1} ) ( α + ζ ) dF / dV \qquad ( 13 )$$

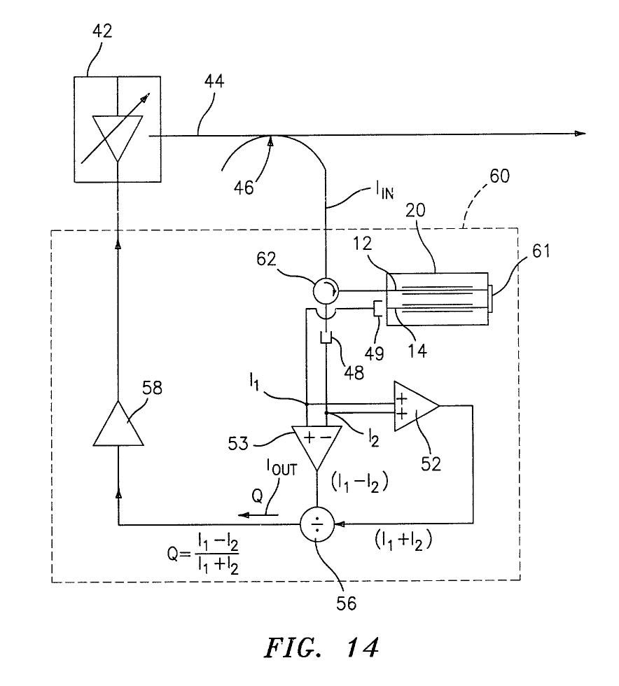

We note that the wavelength and temperature sensitivity are proportional; consequently, the largest temperature changes in cross-talk occur for designs with a short beat wavelength λ_{b}. Conversely, a TDDC fiber 20, which has a short beat length will also be weakly temperature sensitive because dF/dV is small. Curves of the beat temperature vs. V will be similar to analogous plots of the beat wavelength. FIG. 16 shows that temperature stabilization of a few degrees will be sufficient to hold changes in the beat phase to less than 1/100 of a cycle for a dual core wavelocker design for a step-index fiber with a beat wavelength of 3.49 nm. Although FIG. 10, is for a step-index fiber the results closely approximate a TDDC fiber 20 with a small value of \overline{D}. The temperature sensitivity scales the same as the wavelength dependence with the numerical aperture NA and fiber length L. It is generally low, for short TDDC fibers 20 with small numerical aperture cores 12,14.

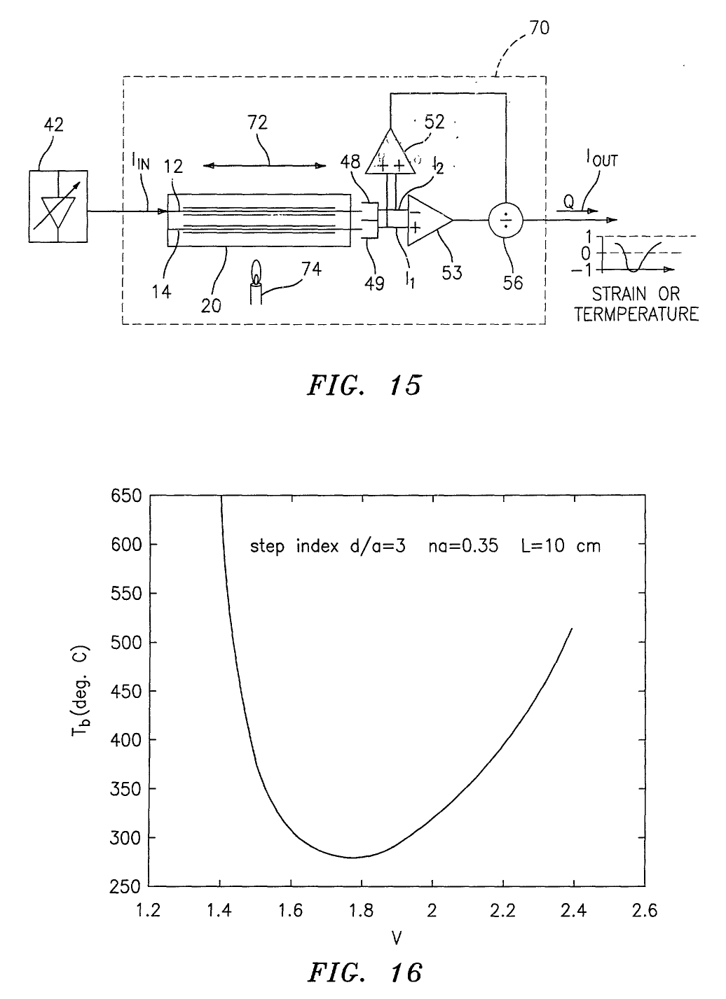

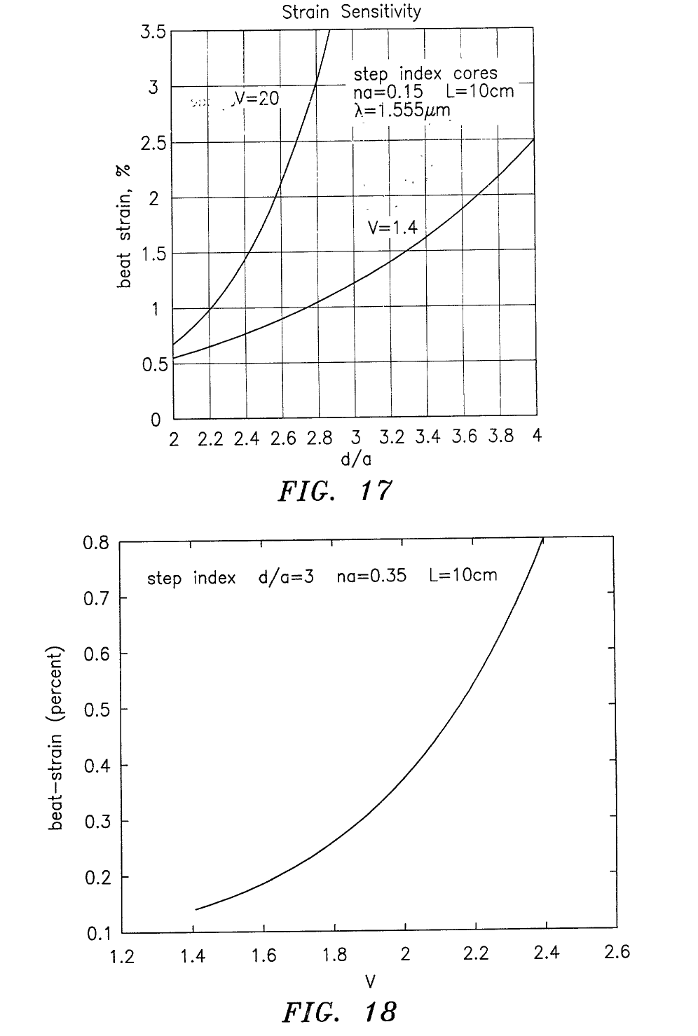

The longitudinal strain sensitivity follows from the equation for beat length and Eq. (12) in the plane strain approximation:

$$\frac{ⅆ φ}{ⅆ {ϵ}_{z}} = E \frac{ⅆ φ}{ⅆ {σ}_{z}} = ( π L / {L}_{b} ) [ ( 1 + v ) - ( v + {p}_{e} ) {VF}^{′} / F ] \qquad ( 14 )$$

where E is Young's modulus, v is the Poisson's ratio and pₑ is the effective photoelastic coefficient which is approximately 0.22. The sensitivity will be greatest for TDDC fibers 20 with short beat lengths as can be seen in FIGS. 17 and 18 which plot the relative core spacing d/a and the beat strain as a function of V, respectively. A few tenths percent strain will be sufficient to tune the wavelocker through a 200 GHz channel spacing.

The temperature and strain can be measured simultaneously by illuminating the input core of the TDDC fiber 20 with two wavelengths and using a filter or spectrum analyzer to measure Q at each wavelength.

While the embodiments of the present invention of a TDDC fiber 20 has been described as having a pair of cores 12,14 disposed within an outer cladding, one will appreciate that the TDDC fiber may have more than a pair of thermally diffused cores. Further, one will appreciate that the cores 12,14 of the TDDC fiber 20 may be different prior to being thermally diffused. For instance, the cores have different diameters, geometries, cross-sectional shapes, and composition of material and dopants. Further, the axis of the waveguide is not required to be disposed between the axes of the cores, nor at equal distances between the axes of the cores.

The dimensions and geometries for any of the embodiments described herein are merely for illustrative purposes and, as much, any other dimensions may be used if desired, depending on the application, size, performance, manufacturing requirements, or other factors, in view of the teachings herein.

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein without departing from the spirit and scope of the present invention.

What is claimed is:

1. An optical waveguide comprising:
at least a first core and a second core disposed within a cladding, the first and second cores comprising a dopant;
wherein the dopants of a portion of the first and second core are thermally-diffused into the cladding to permit light that propagates in the first core to optically couple to the second core.

2. The waveguide of claim 1, wherein the dopants of the thermally diffused portion of the first and second cores overlap.

3. The waveguide of claim 1, wherein the dopants of the thermally diffused portion of the first and second cores are spaced a predetermined distance.

4. The waveguide of claim 1, wherein the optical waveguide is an optical fiber.

5. The waveguide of claim 1, wherein the first core and second core have the same characteristics.

6. The waveguide of claim 1, wherein at least one of the composition, the cross-sectional geometry, and the diameter of the first core and second core are different.

7. The waveguide of claim 1, wherein the length of the thermally-diffused portion of the first and second cores is substantially equal to one half of the beat length.

8. The waveguide of claim 2, wherein the overlapping portion of the thermally-diffused portion of the first and second cores has a circular cross-sectional shape.

9. The waveguide of claim 2, wherein the overlapping portion of the thermally-diffused portion of the first and second cores has an elliptical cross-sectional shape.

10. The waveguide of claim 1, wherein the first core and second core prior to thermal-diffusion are spaced to prevent optical coupling between the first and second cores.

11. The waveguide of claim 1, wherein the first core and second core prior to thermal-diffusion are spaced to optically couple the light from the first core to the second core.

12. The waveguide of claim 1, wherein an intermediate portion of the thermally-diffused portion of the first and second cores is substantially uniform, and end portions of the thermally-diffused portion taper to non-thermally-diffused portions of the respective first and second cores.

13. An optical wavelocker comprising:
an optical waveguide including at least a first core and a second core disposed within a cladding, the first and second cores comprising a dopant, wherein the dopants of a portion of the first and second core are thermally-diffused into the cladding to permit light that propagates in the first core to optically couple to the second core; and
at least one photodetector for generating at least one electrical signal representative of the light exiting the at least one of the first core and the second core.

14. The wavelocker of claim 13, wherein the at least one photodetector includes a first photodetector for generating a first electrical signal representative of the light exiting the first core, and a second photodetector for generating a second electrical signal representative of the light exiting the second core.

15. The wavelocker of claim 13, further includes a reflective element for reflecting the light propagating through the first and second cores back through the first and second cores, wherein the at least one photodetector generates an electrical signal representative of the light exiting the second core.

16. The wavelocker of claim 13, further includes a feedback circuit that generates an error signal representative of an error between the actual wavelength of the input signal and the desire wavelength of the input signal.

17. The wavelocker of claim 13, wherein the dopants of the thermally-diffused portion of the first and second cores overlap.

18. The wavelocker of claim 13, wherein the dopants of the thermally-diffused portion of the first and second cores are spaced a predetermined distance.

19. The wavelocker of claim 13, wherein the optical waveguide is an optical fiber.

20. The wavelocker of claim 13, wherein the first core and second core have the same characteristics.

21. The wavelocker of claim 13, wherein at least one of the composition, the cross-sectional geometry, and the diameter of the first core and second core are different.

22. The wavelocker of claim 13, wherein the length of the thermally-diffused portion of the first and second cores is substantially equal to one half of the beat length.

23. The wavelocker of claim 13, wherein the first core and second core prior to thermal-diffusion are spaced to prevent optical coupling between the first and second cores.

24. The wavelocker of claim 13, wherein an intermediate portion of the thermally-diffused portion of the first and second cores is substantially uniform, and end portions of the thermally-diffused portion taper to non-thermally-diffused portions of the respective first and second cores.

25. A method for forming a thermally-diffused dual core waveguide, the method comprising:
providing a waveguide having at least a first core and a second core disposed within a cladding, the first and second cores comprising a dopant;
and heating for a predetermined time and temperature a portion of the waveguide to thermally-diffuse the dopants of a portion of the first and second core into the cladding to permit light that propagates in the first core to optically couple to the second core.

26. The method of claim 25, wherein the dopants of the thermally-diffused portion of the first and second cores overlap.

27. The method of claim 25, wherein the dopants of the thermally-diffused portion of the first and second cores are spaced a predetermined distance.

28. The method of claim 25, wherein the optical waveguide is an optical fiber.

29. The method of claim 25, wherein the first core and second core have the same characteristics.

30. The method of claim 25, wherein at least one of the composition, the cross-sectional geometries, and the diameter of the first core and second core are different.

31. The method of claim 25, wherein the first core and second core prior to thermal-diffusion are spaced to prevent optical coupling between the first and second cores.

32. The method of claim 25, wherein an intermediate portion of the thermally-diffused portion of the first and second cores is substantially uniform, and end portions of the thermally-diffused portion taper to non-thermally-diffused portions of the respective first and second cores.

33. An optical sensor comprising:
an optical waveguide including at least a first core and a second core disposed within a cladding, the first and second cores comprising a dopant, wherein the dopants of a portion of the first and second core are thermally-diffused into the cladding to permit light that propagates in the first core to optically couple to the second core; and
at least one photodetector for generating at least one electrical signal representative of the light exiting the first core and light exiting the second core, wherein the intensity of light coupling from the first core to the second core is dependent on at least one of the temperature and pressure applied to the optical waveguide.
